(19) United States
(12) Patent Application Publication
(10) Pub. No.: US 2018/0131908 A1
(43) Pub. Date: May 10, 2018

(54) VISOR ASSEMBLY FOR A VEHICLE

(71) Applicant: Ford Global Technologies, LLC, Dearborn, MI (US)

(72) Inventors: Stuart C. Salter, White Lake, MI (US); Annette Lynn Huebner, White Lake, MI (US); Kristin Ann Hellman, Walled Lake, MI (US); Mark Larry, Macomb Township, MI (US)

(21) Appl. No.: 15/348,260

(22) Filed: Nov. 10, 2016

(51) Int. Cl. H04N 7/18; H04N 5/232; H04N 5/225; G06F 3/041; B60J 3/02; B60Q 3/02; B60R 1/00

(52) U.S. Cl. CPC H04N 7/183; H04N 5/23216; H04N 5/2256; H04N 5/23296; B60R 2300/8006; B60J 3/0204; B60Q 3/0226; B60R 1/00; B60R 2300/103; G06F 3/0412

(57) ABSTRACT

A visor assembly for a vehicle includes a touchscreen. The touchscreen has a touch-sensitive layer, a metalized layer, and a display layer. The display layer is positioned furthest from a user of the visor assembly. The metalized layer is positioned in front of the display layer. The touch-sensitive layer is positioned in front of the metalized layer. The visor assembly further includes at least one of a camera and a light source.

### FIELD OF THE INVENTION

The present disclosure generally relates to visor assemblies. More specifically, the present disclosure relates to visor assemblies for motor vehicles.

### BACKGROUND OF THE INVENTION

Vehicles often include visors for use by vehicle occupants. The visors can be used for a limited number of tasks and functionality. Accordingly, it may be advantageous to provide visors for vehicle occupants that have increased functionality.

### SUMMARY OF THE INVENTION

According to one aspect of the present disclosure, a visor assembly for a vehicle includes a touchscreen that has a touch-sensitive layer, an air gap, a metalized layer, and a display layer. The display layer is positioned furthest from a user of the visor assembly. The metalized layer is positioned in front of the display layer and the touch-sensitive layer is positioned in front of the metalized layer. The air gap separates the touch-sensitive layer from the metalized layer a distance of not more than five millimeters. A camera is positioned above the touchscreen. The camera is centered above the touchscreen. A light source is positioned continuously about a perimeter of the touchscreen.

According to another aspect of the present disclosure, a visor assembly for a vehicle includes a touchscreen that has a touch-sensitive layer, a metalized layer, and a display layer. The display layer is positioned furthest from a user of the visor assembly. The metalized layer is positioned in front of the display layer and the touch-sensitive layer is positioned in front of the metalized layer. A light source is positioned about a perimeter of the touchscreen.

According to yet another aspect of the present disclosure, a visor assembly for a vehicle includes a touchscreen that has a touch-sensitive layer, a metalized layer, and a display layer. The display layer is positioned furthest from a user of the visor assembly. The metalized layer is positioned in front of the display layer and the touch-sensitive layer is positioned in front of the metalized layer. A camera is positioned in the visor assembly.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is a front view of a visor assembly in a deployed position having a cover over a touchscreen with the cover in a closed position;

FIG. 2 is a front view of the visor assembly, similar to FIG. 1, with the cover in an open position to expose the touchscreen;

FIG. 3 is a front view of the visor assembly, according to another embodiment, without the cover of the touchscreen;

FIG. 4 is a cross-sectional view of the touchscreen taken along line IV-IV of FIG. 3 according to one embodiment; and

FIG. 5 is a cross-sectional view of the touchscreen taken along line IV-IV of FIG. 3, according to another embodiment.

### DETAILED DESCRIPTION OF THE PREFERRED EMBODIMENTS

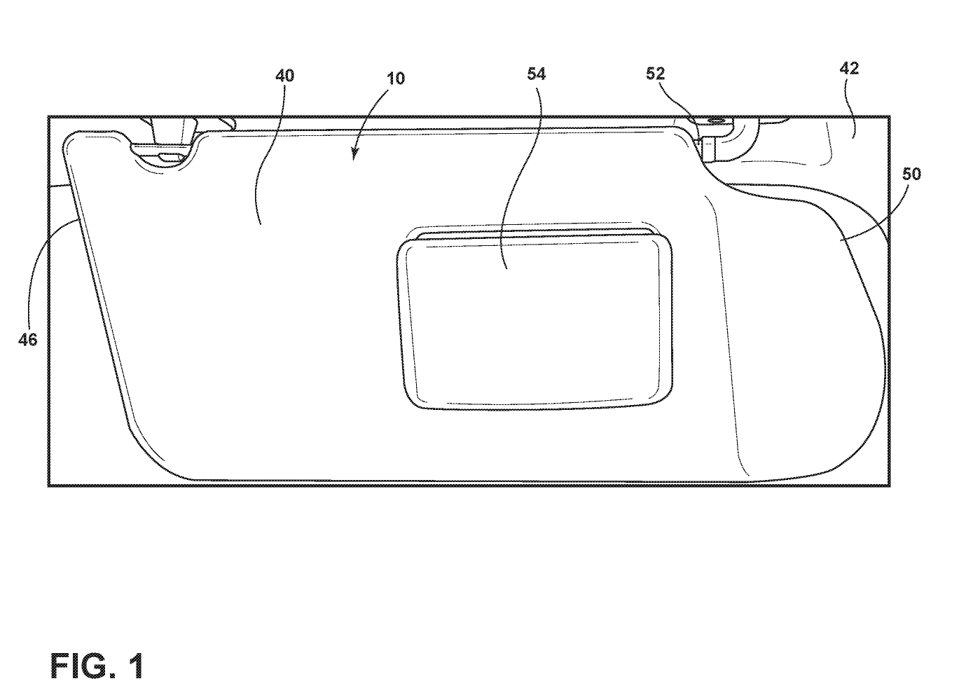

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a visor assembly for a vehicle. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Referring to FIGS. 1-5, reference numeral 10 generally designates a visor assembly for a vehicle, such as a wheeled motor vehicle. The visor assembly 10 includes a touchscreen 14 having a touch-sensitive layer 18, an air gap 22, a metalized layer 26, and a display layer 30. The display layer 30 is furthest from a user of the visor assembly 10. The metalized layer 26 is positioned in front of the display layer 30. The touch-sensitive layer 18 is positioned in front of the metalized layer 26 with the air gap 22 separating the touch-sensitive layer 18 from the metalized layer 26 a distance of not more than five millimeters. A camera 34 is positioned above the touchscreen 14 and the camera 34 is centered above the touchscreen 14. A light source 38 is positioned about a perimeter of the touchscreen 14.

Referring now to FIG. 1, the visor assembly 10 includes the touchscreen 14 and a visor 40. The visor 40 is configured to block sunlight when the visor assembly 10 is in a deployed position. The visor 40 can be made of a rigid or semi-rigid core material that is wrapped with fabric or cover stock that matches or compliments the interior of the vehicle. Additionally, the touchscreen 14 of the visor assembly 10 can be positioned within visor 40. For example, the touchscreen 14 can be positioned in the core of the visor 40 and sized to protrude through at least one of the front surface and the rear surface of the visor assembly 10. Alternatively, the touchscreen 14 can serve the additional purpose of acting as the visor 40, such that the size and dimensions of the touchscreen 14 are substantially similar to a conventional visor 40. The visor assembly 10 is detachably coupled to a roof 42 of the vehicle at a first end 46 of the visor assembly 10 and pivotally coupled to the roof 42 of the vehicle at a second end 50 of the visor assembly 10. A shaft 52 traverses the width of the visor assembly 10 at least between the point of detachable coupling of the first end 46 of the visor assembly 10 and the point of pivotal coupling to the roof 42 of the vehicle at the second end 50 of the visor assembly 10.

Referring again to FIG. 1, the visor assembly 10 is equipped with a cover 54 that is hingedly coupled to the visor assembly 10 and configured to cover and thereby protect the touchscreen 14 from damage when the cover 54 is in a closed position. The cover 54 can include a switch or sensor, for example in the hinge mechanism, the visor 40, and/or the touchscreen 14, which is configured to turn on the light source 38 and/or turn on the camera 34.

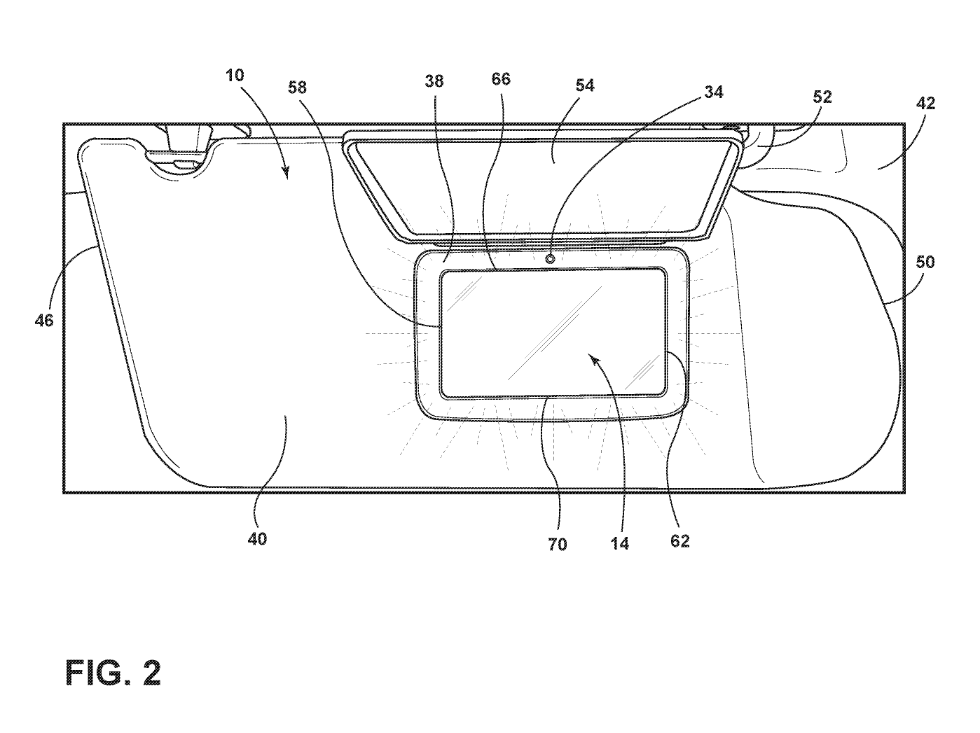

Referring to FIG. 2, the cover 54 can be seen in an open position. The touchscreen 14 is shown as a generally rectangular shape. However, the touchscreen 14 can take other shapes such as circles, ovals, squares, triangles, parallelograms, and various other polygons without departing from the concepts disclosed herein. Additionally, the touchscreen 14 can be an indium tin oxide based touchscreen 14. Alternatively, the touchscreen 14 can be a clear conductive ink based touchscreen 14. The touch-sensitive layer 18 of the touchscreen 14 can function, for example and without limitation, by using conductive and/or inductive sensors that inform the touchscreen 14 about the area of the touchscreen 14 that has been touched by the user. The light source 38 can be positioned continuously about a perimeter of the touchscreen 14. While the light source 38 is shown as being positioned continuously about the perimeter of the touchscreen 14, it is contemplated that the light source 38 can be otherwise positioned about the perimeter of the touchscreen 14 without departing from the concepts disclosed herein. For example, the light source 38 can include independent light sources positioned on a left side 58, a right side 62, a top side 66, and/or a bottom side 70 of the touchscreen 14 such that each of the independent light sources 38 are not interconnected with one another in a continuous fashion about the perimeter of the touchscreen 14. The discontinuous light source 38 can take the form, for example and without limitation, of independent lighting assemblies that do not interconnect with the other independent light sources, such light sources 38 can be sized to substantially correspond with the length of at least one of the left side 58, the right side 62, the top side 66, or the bottom side 70. Alternatively, the discontinuous light source 38 can take the form, for example and without limitation, of individual light emitting diodes (LEDs) positioned about the perimeter of the touchscreen 14.

Referring further to FIG. 2, the camera 34 is shown positioned in the visor 40 of the visor assembly 10 and is configured to image an occupant of a vehicle seat that is associated with the visor assembly 10. The camera 34 is further configured to display the image of the occupant of the associated vehicle seat to the display layer 30 of the touchscreen 14. For example, a passenger's face captured by the camera 34 may be displayed on the touchscreen 14. The camera 34 can be a high resolution camera, such as a two megapixel or greater camera. High resolution cameras can also be capable of capturing high definition (HD) images and videos, such as 720i, 720p, 1080i, 1080p, and/or 4K definition. The camera 34 can be equipped with digital zoom functionality and/or optical zoom functionality. The camera 34, as shown, is positioned above the touchscreen 14 and is centered laterally in relation to the width of the touchscreen 14 according to one embodiment. The camera 34 can be positioned within an upper lateral portion of the light source 38 that traverses the top side 66 of the touchscreen 14. Alternatively, the camera 34 can be positioned behind the touchscreen 14 and configured to view through the touchscreen 14, similar to a two-way mirror, such that when the occupant of the associated vehicle seat desires to capture an image of themselves, they can simultaneously be viewing their reflection while looking directly into the lens of the camera 34.

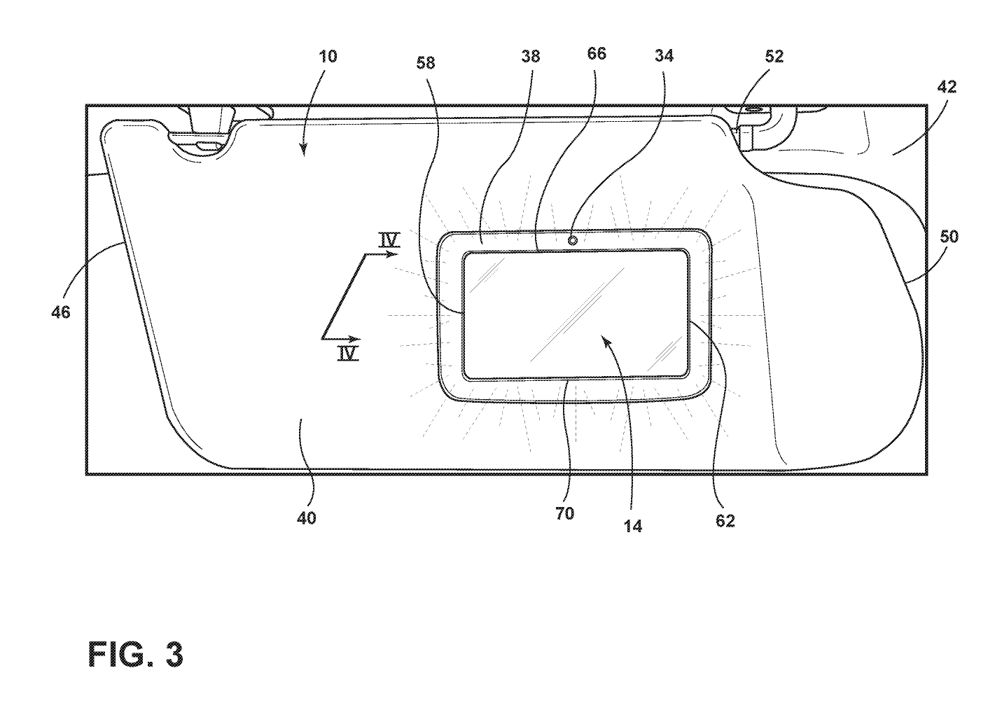

Referring now to FIG. 3, the touchscreen 14 is shown without the cover 54. In this embodiment, the camera 34 can be additionally configured as a sensor. The camera 34 can be used to sense a change in environmental lighting. That is, the camera 34 can be used to determine when the visor assembly 10 has been rotated from a stowed position to the deployed position. When the visor assembly 10 is rotated from the stowed position to the deployed position, the camera 34 can sense the change in the lighting of its environment such that the camera 34 is powered on to display an image on the touchscreen 14. Alternatively, the rotation of the visor assembly 10 on the shaft 52 can activate a sensor or switch on the shaft 52 such that the camera 34 is turned on and displays an image on the touchscreen 14. In another alternative embodiment, the camera 34 can remain off unless activated by the user such that the touchscreen 14 functions as a conventional mirror while the camera 34 is powered off. When the camera 34 is powered on, the display layer 30 is activated and displays what is viewed by the camera 34.

Referring further to FIG. 3, the touchscreen 14 is shown as a generally rectangular shape. However, the touchscreen 14 can take other shapes such as circles, ovals, squares, triangles, parallelograms, and various other polygons without departing from the concepts disclosed herein. The light source 38 can be positioned continuously about a perimeter of the touchscreen 14. While the light source 38 is shown as being positioned continuously about the perimeter of the touchscreen 14, it is contemplated that the light source 38 can be otherwise positioned about the perimeter of the touchscreen 14 without departing from the concepts disclosed herein. For example, the light source 38 can include independent light sources positioned on the left side 58, the right side 62, the top side 66, and/or the bottom side 70 of the touchscreen 14 such that each of the independent light sources 38 are not interconnected with one another in a continuous fashion about the perimeter of the touchscreen 14.

Referring again to FIG. 3, the camera 34 is positioned in the visor assembly 10 and is configured to view an occupant of a vehicle seat that is associated with the visor assembly 10. The camera 34 is further configured to display the image of the occupant of the associated vehicle seat to the display layer 30 of the touchscreen 14. The camera 34 can be a high resolution camera, such as a two megapixel or greater camera. High resolution cameras can also be capable of capturing high definition (HD) images and videos, such as 720i, 720p, 1080i, 1080p, and/or 4K definition. The camera 34 can be equipped with digital zoom functionality and/or optical zoom functionality. The camera 34, as shown, is positioned above the touchscreen 14 and is centered laterally in relation to the width to the touchscreen 14. The camera 34 can be positioned within an upper lateral portion of the light source 38 that traverses the top side 66 of the touchscreen 14. Alternatively, the camera 34 can be positioned behind the touchscreen 14 and configured to view through the touchscreen 14, similar to a two-way mirror, such that when the occupant of the associated vehicle seat desires to capture an image of themselves, they can simultaneously be viewing their reflection while looking directly into the lens of the camera 34.

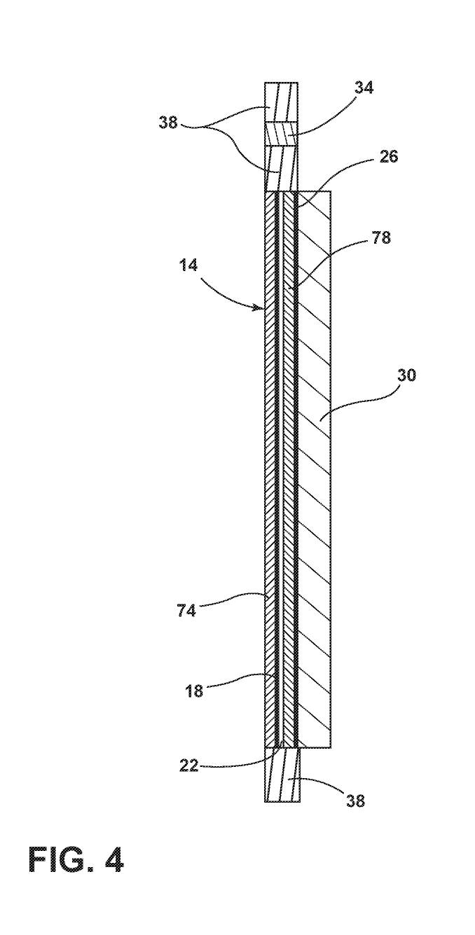

Referring to FIG. 4, the touchscreen 14 includes the touch-sensitive layer 18, the metalized layer 26, the display layer 30, and optionally the air gap 22. The touch-sensitive layer 18 can be operably coupled to an interior or rear surface of a first substrate 74. The first substrate 74 can be made of a transparent or substantially transparent material (e.g. glass, polycarbonate, etc.). The touch-sensitive layer 18 can be equipped with a series of electrodes that are provided with a potential, such that an interruption or disturbance to the field flow between the electrodes can be sensed by the touchscreen 14 via the metalized layer 26. The display layer 30 is positioned furthest from a user of the visor assembly 10. The metalized layer 26 is positioned in front of the display layer 30. The metalized layer 26 is held at ground potential. The metalized layer 26 can be created by physical vapor deposition or partial vacuum metallization of a metal onto a second substrate 78. The second substrate 78 can be the same or different than the first substrate 74. For example, the second substrate 78 can be made of a transparent or substantially transparent material (e.g. glass, polycarbonate, etc.). Alternatively, the metalized layer 26 can be a thin metal film that is cut to the desired dimensions and applied to the second substrate 78. The surface of the second substrate 78 that is metalized can be proximal to the display layer 30. Alternatively, the surface of the second substrate 78 that is metalized can be proximal to the touch-sensitive layer 18. The touch-sensitive layer 18 is positioned in front of the metalized layer 26. The air gap 22 can be used to separate the touch-sensitive layer 18 from the metalized layer 26. The air gap 22 can provide the touch-sensitive layer 18 with additional insulation from the metalized layer 26. The air gap 22 can be used to increase the sensitivity of the touchscreen 14, which can improve consumer experience.

Referring further to FIG. 4, when the touchscreen 14 is equipped with the air gap 22, the distance between the touch-sensitive layer 18 to a front surface of the display layer 30 can be used to tune the sensitivity of the touchscreen 14 to user input (e.g. touching with a finger). For example, the distance between the surface of the touch-sensitive layer 18 to the front surface of the display layer 30 can be less than or equal to about 10 mm, 9 mm, 8 mm, 7 mm, 6 mm, 5 mm, 4 mm, 3 mm, 2 mm, 1 mm, 0.5 mm, 0.25 mm, or less than or equal to about 0.1 mm. Alternatively, or in addition to, the distance between the touch-sensitive layer 18 to the metalized layer 26 can be less than or equal to about 10 mm, 9 mm, 8 mm, 7 mm, 6 mm, 5 mm, 4 mm, 3 mm, 2 mm, 1 mm, 0.5 mm, 0.25 mm, 0.1 mm, or the touch-sensitive layer 18 and the metalized layer 26 can be in physical contact with one another. It may be advantageous to have the distance between the touch-sensitive layer 18 to the display layer 30 not more than five millimeters, for example, to increase sensitivity of the touchscreen 14 without placing the metalized layer 26 outside of the most effective range of the touch-sensitive layer 18. Alternatively, it may be advantageous to have the distance between the touch-sensitive layer 18 to the display layer 30 be greater than two millimeters to increase the sensitivity of the touchscreen 14 without placing the metalized layer 26 close enough to inhibit the sensitivity of the touch-sensitive layer 18. It may additionally or alternatively be advantageous to have the distance between the touch-sensitive layer 18 to the metalized layer 26 not more than five millimeters, for example, to increase sensitivity of the touchscreen 14 without placing the metalized layer 26 outside of the most effective range of the touch-sensitive layer 18. It may be additionally or alternatively advantageous to have the distance between the touch-sensitive layer 18 to the metalized layer 26 be greater than two millimeters to increase the sensitivity of the touchscreen 14 without placing the metalized layer 26 close enough to inhibit the sensitivity of the touch-sensitive layer 18.

Referring again to FIG. 4, the display layer 30 can display an image from the camera 34, such as a face of the occupant of the vehicle seat that is associated with the visor assembly 10. Alternatively, or in addition to, the touchscreen 14 can function as a two-way mirror such that when the display layer 30 and/or the camera 34 is off a user of the visor assembly 10 can use the touchscreen 14 as a conventional mirror. Once the camera 34 is turned on, the display layer 30 can then display the image captured by the camera 34. The light source 38 is shown on the top side 66 and the bottom side 70 of the touchscreen 14. Additionally, the light source 38 is shown abutting the edges of the touchscreen 14. However, one of skill in the art will recognize that the light source 38 can be alternatively positioned without departing from the concepts disclosed herein.

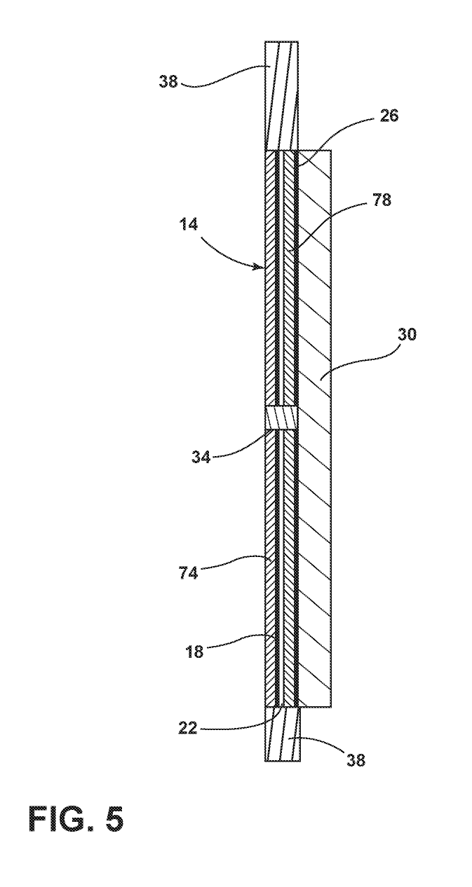

Referring now to FIG. 5, the touchscreen 14 includes the touch-sensitive layer 18, the metalized layer 26, the display layer 30, and optionally the air gap 22 according to another embodiment. The touch-sensitive layer 18 can be operably coupled to an interior or rear surface of the first substrate 74. The first substrate 74 can be made of a transparent or substantially transparent material (e.g. glass, polycarbonate, etc.). The touch-sensitive layer 18 can be equipped with a series of electrodes that are provided with a potential, such that an interruption or disturbance to the field flow between the electrodes can be sensed by the touchscreen 14 via the metalized layer 26. The display layer 30 is positioned furthest from a user of the visor assembly 10. The metalized layer 26 is positioned in front of the display layer 30. The metalized layer 26 is held at ground potential. The metalized layer 26 can be created by physical vapor deposition or partial vacuum metallization of a metal onto the second substrate 78. The second substrate 78 can be the same or different than the first substrate 74. For example, the second substrate 78 can be made of a transparent or substantially transparent material (e.g. glass, polycarbonate, etc.). Alternatively, the metalized layer 26 can be a thin metal film that is cut to the desired dimensions and applied to the second substrate 78. The surface of the second substrate 78 that is metalized can be proximal to the display layer 30. Alternatively, the surface of the second substrate 78 that is metalized can be proximal to the touch-sensitive layer 18. The touch-sensitive layer 18 is positioned in front of the metalized layer 26. The air gap 22 can be used to separate the touch-sensitive layer 18 from the metalized layer 26. The air gap 22 can provide the touch-sensitive layer 18 with additional insulation from the metalized layer 26. The air gap 22 can be used to increase the sensitivity of the touchscreen 14, which can improve consumer experience. The display layer 30 can display an image from the camera 34, such as a face of the occupant of the vehicle seat that is associated with the visor assembly 10. Alternatively, or in addition to, the touchscreen 14 can function as a two-way mirror such that when the display layer 30 and/or the camera 34 is off a user of the visor assembly 10 can use the touchscreen 14 as a conventional mirror. Once the camera 34 is turned on, the display layer 30 can then display the image captured by the camera 34.

Referring again to FIG. 5, the camera 34 is positioned within the viewing area of the touchscreen 14. Positioning the camera 34 within the viewing area of the touchscreen 14 can result in a perceived “dead” pixel in the display layer 30 at the point where the camera 34 is located. However, the locating of the camera 34 within the viewing area of the touchscreen 14 is such that the overall experience of the user is not affected or impeded. Additionally, the perceived dead pixel in the display layer 30 provides the user of the touchscreen 14 an indication of where the camera 34 is located, which aids the user in knowing where to look at the touchscreen 14 to capture an image where they are looking directly into the camera 34 lens. The camera 34 is shown located in front of the display layer 30 and within the touch-sensitive layer 18, the air gap 22, and the metalized layer 26. It is contemplated that the camera 34 can be otherwise located within the viewing area of the touchscreen 14. For example, the camera 34 can be located within the display layer 30 and the metalized layer 26 but behind the touch-sensitive layer 18 and/or the air gap 22. Alternatively, the camera 34 can be located in front of the display layer 30, behind the touch-sensitive layer 18, and within the metalized layer 26 and/or the air gap 22. The light source 38 is shown on the top side 66 and the bottom side 70 of the touchscreen 14. Additionally, the light source is shown abutting the edges of the touchscreen 14. However, one of skill in the art will recognize that the light source 38 can be alternatively positioned without departing from the concepts disclosed herein.

The touchscreen 14 of the present disclosure can be used in various ways. For example, the user of the touchscreen 14 can zoom in and/or zoom out of the image displayed by the camera 34 by pinching two fingers together while touching the touchscreen 14 or by spreading two fingers apart while touching the touchscreen 14, respectively. The zooming feature of the camera 34 can be accomplished by digital and/or optical zoom. The digital zoom can be accomplished by the camera 34 having sufficient pixel density to allow zooming of the image displayed without mechanical focusing functionality. The optical zoom can be accomplished by the camera 34 being equipped with at least one mechanical focusing lens that physically moves when the user zooms in and/or zooms out of the image displayed. The touchscreen 14 can be a video implementing thin display, such as an OLED, an LED, an LCD, or the like. The dimensions of the visor assembly 10 present restrictive packaging requirements that place a premium on conserving space and minimizing thickness where possible. The use of the thin display aids in maintaining a thin touchscreen 14 package.

Further interactions with the touchscreen 14 can be activated by various “tap” commands on the touchscreen 14. For example, a single tap of the touchscreen 14 can magnify the lighting from the light source 38. Alternatively, the single tap of the touchscreen 14 can bring up a lighting menu or slide-scale that allows the user to customize the light from the light source 38 to their preferences for a given task. A tap-tap, or double tap, of the touchscreen 14 can increase the intensity of the light from the light source 38 and/or activate the camera 34 to display an image on the display layer 30. The single tap and double tap functionality can be independent of the functionality of the camera 34 and/or the display layer 30, thereby allowing the user to enjoy the functionality of the touchscreen 14 as a conventional mirror with improved lighting from the light source 38, even if the camera 34 and/or the display layer 30 fail.

During a single tap and/or a double tap, the light source 38 will change to enhance the experience of the user. For example, the light source 38 will change from a warm white illumination (about 3,000 Kelvins) to a daylight illumination (about 6,000 Kelvins), which is a blue shift from the warm white illumination. The warm white illumination can be useful for general viewing in the touchscreen 14. However, viewing ones reflection in the range of 6,000 to 10,000 Kelvins tends to bring out more details and offer greater contrast, which can improve one's ability to evaluate their reflection/image. Therefore, the light source 38 of the present disclosure is capable of illumination at least in the range of 6,000 to 10,000 Kelvins. The light source 38 can be controlled such that the illumination of the light source 38 can be ramped gradually. For example, the light source 38 can be ramped gradually over the course of about two seconds to increase the illumination by a factor of five. This gradual ramping of the illumination of the light source 38 prevents uncomfortable shock to the user's eyes. By increasing the illumination of the light source 38, the noise of the reflection and/or picture being displayed is decreased. Increased illumination can improve the human eye's ability to see fine details and can improve the picture captured by the camera 34. The change in illumination can be relative to the light intensity outside of the vehicle, as sensed by a day-night sensor within the vehicle. For example, during daylight hours the single tap of the touchscreen 14, where the user is utilizing the touchscreen 14 as a conventional mirror, can provide the light source 38 as a more intense illumination device than during nighttime hours. During daytime hours it is likely that the user's eyes will be adjusted to the light intensity of the outdoors. However, during nighttime hours the user's eyes may not have adjusted to the change in lighting conditions yet. Fully adjusting to the change in lighting conditions can take up to forty-five minutes for human eyes. The day-night sensor informs the light source 38 of the present lighting conditions outside of the vehicle to avoid shocking the user's eyes in low light conditions. That is, the day-night sensor can inform the light source 38 as to an illumination level and/or an illumination ramp speed. When using the touchscreen 14 as a conventional mirror during nighttime hours, human eyes can see well at lower levels of illumination than typical economical cameras. Therefore, the increased illumination may not be necessary to perform some tasks or functionalities of the touchscreen 14 during nighttime hours. When the user employs the functionalities associated with the double tap, such as utilizing the camera 34, during nighttime hours, then the gradual ramping of the light source 38 can be extended over a longer period of time. For example, the gradual ramping of the light source 38 can be extended from two seconds to five seconds during nighttime hours. The speed of the gradual ramping can be customized by the user. By increasing the time for the gradual ramping, the camera 34 can be provided with the increased light intensity that improves the performance of the camera 34 while avoiding shocking the eyes of the user during nighttime hours.

Following activation of the camera 34 by the double tap of the touchscreen 14, the pinch and spread zoom functionality can be utilized. When in the camera mode of the touchscreen 14, which follows the double tap activation of the camera 34, the camera 34 can display a real-time video to the display layer 30 of the touchscreen 14. A downward swipe on the touchscreen 14 can cause the picture displayed on the touchscreen 14 to be frozen, or a picture taken, for closer inspection by the user. The closer inspection can be accomplished by the two finger spread functionality described above. After a first predetermined and customizable time period, such as fifteen seconds, of inactivity on the touchscreen 14 then the camera 34 can return to a dormant or off mode. Once the camera 34 has gone dormant or turned off, the light source 38 can remain on until the user turns off the light source 38, for example by a tap-and-hold interaction with the touchscreen 14, by closing the cover 54, or by placing the visor assembly 10 in the stowed position. Alternatively, the light source 38 can automatically turn off after a second predetermined and customizable time period, such as forty-five seconds, of inactivity on the touchscreen 14.

Additionally, the camera 34 in the visor assembly 10 can be enabled through the touchscreen 14 or a mobile device (e.g. smartphone) to function as an internal security camera for the vehicle. Further, the touchscreen 14 can link to a user's smartphone or other electronic device, for example by Bluetooth, to upload pictures or videos taken by the camera 34 in the visor assembly 10 (e.g. selfies). Still further, the touchscreen 14 can provide a picture and/or video link to an electronic device of the user or directly to the vehicle via a multiplex interface (e.g. wirelessly, Bluetooth, bus, etc.) for transmission over the internet.

Occupants of vehicles use mirrors in the visor assembly 10 for a variety of tasks and functions. These tasks and functions include, but are not limited to, blocking sunlight, putting on makeup, putting in and/or taking out contacts, checking overall appearance, looking for an irritant in the eye (e.g. an eyelash), and checking teeth for food or other debris. Due to the seat position and the restraint system, it can be difficult to view ones reflection closely in the mirror, as is beneficial for various tasks and functions. Additionally, due to lighting being different at different times of day, it may be difficult to view a specific area that one would like to view. To overcome the various disadvantages present with conventional mirrors in visor assemblies 10, the touchscreen 14 is provided with the camera 34 to facilitate various levels of magnification of the image displayed by the camera 34. Further, the light source 38 provides bright and diffuse lighting by spreading the light source 38 out about the perimeter of the touchscreen 14. The bright and diffuse lighting is beneficial for both traditional mirror use and improves the performance of the camera 34.

Modifications of the disclosure will occur to those skilled in the art and to those who make or use the concepts disclosed herein. Therefore, it is understood that the embodiments shown in the drawings and described above are merely for illustrative purposes and not intended to limit the scope of the disclosure, which is defined by the following claims as interpreted according to the principles of patent law, including the doctrine of equivalents.

It will be understood by one having ordinary skill in the art that construction of the described concepts, and other components, is not limited to any specific material. Other exemplary embodiments of the concepts disclosed herein may be formed from a wide variety of materials, unless described otherwise herein.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature, or may be removable or releasable in nature, unless otherwise stated.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connector or other elements of the system may be varied, and the nature or numeral of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes, or steps within described processes, may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further, it is to be understood that such concepts are intended to be covered by the following claims, unless these claims, by their language, expressly state otherwise.

What is claimed is:

1. A visor assembly for a vehicle, comprising:
a visor;
a touchscreen having a touch-sensitive layer, an air gap, a metalized layer, and a display layer, and wherein the display layer is positioned furthest from a user of said visor assembly, the metalized layer is positioned in front of the display layer, and the touch-sensitive layer is positioned in front of the metalized layer with the air gap separating the touch-sensitive layer from the metalized layer a distance of not more than five millimeters;
a camera positioned on the visor; and
a light source positioned continuously about a perimeter of the touchscreen.

2. The visor assembly for a vehicle of claim 1, wherein the camera is positioned within an upper lateral portion of the light source.

3. The visor assembly for a vehicle of claim 1, wherein the camera is a high resolution camera equipped with digital zoom functionality.

4. The visor assembly for a vehicle of claim 1, wherein the camera is equipped with optical zoom functionality.

5. The visor assembly for a vehicle of claim 1, wherein the touchscreen is an indium tin oxide based touchscreen.

6. The visor assembly for a vehicle of claim 1, wherein the touchscreen is a clear conductive ink based touchscreen.

7. The visor assembly for a vehicle of claim 1, wherein the visor further comprises:
a core material; and
a cover stock over the core material.

8. A visor assembly for a vehicle, comprising:
a touchscreen having a touch-sensitive layer, a metalized layer, and a display layer, wherein the display layer is positioned furthest from a user of said visor assembly, the metalized layer is positioned in front of the display layer, and the touch-sensitive layer is positioned in front of the metalized layer; and
a light source positioned about a perimeter of the touchscreen.

9. The visor assembly for a vehicle of claim 8, further comprising:
a camera positioned in said visor assembly for viewing and displaying the image of an occupant of a vehicle seat.

10. The visor assembly for a vehicle of claim 9, wherein the camera is a high resolution camera equipped with digital zoom functionality.

11. The visor assembly for a vehicle of claim 9, wherein the camera is positioned within the viewing area of the touchscreen.

12. The visor assembly for a vehicle of claim 8, further comprising:
an air gap positioned between the touch-sensitive layer and the metalized layer.

13. The visor assembly for a vehicle of claim 12, wherein the distance between a surface of the touch-sensitive layer to a front surface of the display layer is not more than five millimeters.

14. The visor assembly for a vehicle of claim 12, wherein the distance between a surface of the touch-sensitive layer to a front surface of the display layer is at least two millimeters.

15. A visor assembly for a vehicle, comprising:
a touchscreen having a touch-sensitive layer, a metalized layer, and a display layer, wherein the display layer is positioned furthest from a user of said visor assembly, the metalized layer is positioned in front of the display layer, and the touch-sensitive layer is positioned in front of the metalized layer; and
a camera.

16. The visor assembly for a vehicle of claim 15, further comprising an air gap positioned between the touch-sensitive layer and the metalized layer.

17. The visor assembly for a vehicle of claim 15, further comprising:
a light source positioned about a perimeter of the touchscreen.

18. The visor assembly for a vehicle of claim 17, wherein the light source is capable of illumination in the range of 6,000-10,000 Kelvins.

19. The visor assembly for a vehicle of claim 18, further comprising:
a day-night sensor, wherein the day-night sensor informs the light source as to an illumination level to be provided to the user.

20. The visor assembly for a vehicle of claim 19, wherein the day-night sensor informs the light source as to an illumination ramp speed.
